(19) United States
(12) Patent Application Publication
(10) Pub. No.: US 2024/0097098 A1
(43) Pub. Date: Mar. 21, 2024

(54) MANUFACTURING METHOD AND MANUFACTURING APPARATUS OF ELECTRODE STRUCTURE

(71) Applicant: KABUSHIKI KAISHA TOSHIBA, Tokyo (JP)

(72) Inventors: Kazuomi YOSHIMA, Yokohama Kanagawa (JP); Yuta KANAI, Yokohama Kanagawa (JP); Hirofumi YASUMIISHI, Kawasaki Kanagawa (JP); Tetsuya SASAKAWA, Yokohama Kanagawa (JP)

(73) Assignee: KABUSHIKI KAISHA TOSHIBA, Tokyo (JP)

(21) Appl. No.: 18/176,136

(22) Filed: Feb. 28, 2023

(30) Foreign Application Priority Data
Sep. 16, 2022 (JP) 2022-148157

(51) Int. Cl. H01M 4/04; H01M 4/66

(52) U.S. Cl. CPC H01M 4/0435; H01M 4/661; H01M 4/667

(57) ABSTRACT

In a manufacturing method of an electrode structure of an embodiment, in a belt-like member in which an uncoated region not coated with an active material-containing layer is formed in one of long edges and its vicinity in a current collector, the active material-containing layer is rolled, and a tension in a longitudinal direction is applied to the belt-like member between a pulling unit pulling the belt-like member and a rolling unit rolling the active material-containing layer. In the method, the uncoated region is pushed by a projection projecting to an outer peripheral side in a roller between the rolling unit and the pulling unit, thereby enlarging the uncoated region in the longitudinal direction. A projection length of the projection to the projection end is larger than the thickness of the rolled active material-containing layer.

### CROSS-REFERENCE TO RELATED APPLICATIONS

This application is based upon and claims the benefit of priority from prior Japanese Patent Application No. 2022-148157, filed Sep. 16, 2022; the entire contents of which are incorporated herein by reference.

### FIELD

Embodiments described herein relate generally to a manufacturing method and a manufacturing apparatus of an electrode structure.

### BACKGROUND

In a battery such as a secondary battery, an electrode such as a positive electrode or a negative electrode is formed by an electrode structure. The electrode structure includes a current collector, and an active material-containing layer applied on the surface of the current collector. The current collector has a pair of long edges formed along the longitudinal direction. In the current collector of the electrode structure, an uncoated region in which neither of a pair of principal surfaces is coated with the active material-containing layer is formed in one of the pair of long edges and its vicinity. In the manufacture of the electrode structure like this, the surface of the current collector is coated with the active material-containing layer in a state in which the uncoated region not coated with the active material-containing layer in one of the pair of long edges and its vicinity is formed in the current collector. After the active material-containing layer applied on the current collector is dried, the active material-containing layer is rolled by a roll press or the like while a belt-like member in which the current collector is coated with the active material-containing layer is conveyed.

In the manufacture of the electrode structure, the active material-containing layer is rolled as described above, and the pressure of rolling is applied to a coated region in which at least one of the pair of principal surfaces is coated with the active material-containing layer in the current collector, so the current collector is enlarged in the longitudinal direction. On the other hand, the pressure of rolling is not applied to the uncoated region of the current collector, so the current collector is not enlarged in the longitudinal direction. Consequently, the rolling of the active material-containing layer curves the conveyed belt-like member (current collector) such that a side on which the uncoated region is positioned is the inside of the curve.

In the manufacture of the electrode structure, the curve of the belt-like member produced by the rolling of the active material-containing layer is corrected. In this correction of the belt-like member, the belt-like member is pulled toward the downstream side, on the downstream side of a rolling unit for rolling the active material-containing layer, thereby applying a tension in the longitudinal direction to the belt-like member between a pulling unit for pulling the belt-like member and the rolling unit. Then, the uncoated region of the current collector in the belt-like member to which the tension is applied is pushed by a projection formed on the outer peripheral surface of a guide roller for guiding the belt-like member between the rolling unit and the pulling unit, thereby enlarging the uncoated region in the longitudinal direction and correcting the curve.

Depending on a battery that uses the electrode formed by the electrode structure, it is necessary to increase the width of the uncoated region in the widthwise direction in the belt-like member. In the manufacture of an electrode structure, even if the dimension (width) of the uncoated region in the widthwise direction of the current collector increases, it is required to appropriately correct the curve of the belt-like member produced by rolling of the active material-containing layer.

### BRIEF DESCRIPTION OF THE DRAWINGS

FIG. 1 is a schematic view showing an example of an electrode structure formed in an embodiment, in a state in which the electrode structure is viewed from one side in the thickness direction.

FIG. 2 is a sectional view schematically showing a section of the electrode structure shown in FIG. 1, which is perpendicular to or almost perpendicular to the longitudinal direction.

FIG. 3 is a schematic view showing an example of a manufacturing apparatus for manufacturing an electrode structure in the embodiment.

FIG. 4 is a schematic view showing an example of a measurement method of measuring the curved amount of a belt-like member curved by, for example, rolling of an active material-containing layer.

FIG. 5 is a sectional view schematically showing an example of the configuration of an enlarging unit in the manufacturing apparatus according to the embodiment, by a section parallel to or almost parallel to the axial direction of a guide roller.

FIG. 6 is a sectional view schematically showing the configuration of a projection and its vicinity of the guide roller in the enlarging unit shown in FIG. 5, by a section parallel to or almost parallel to the axial direction of the guide roller.

FIG. 7 is a sectional view schematically showing the configuration of a projection and its vicinity of a guide roller in an enlarging unit of a manufacturing apparatus of a modification, by a section parallel to or almost parallel to the axial direction of the guide roller.

FIG. 8 is a sectional view schematically showing the configuration of a projection and its vicinity of a guide roller in an enlarging unit of a manufacturing apparatus of a modification different from FIG. 7, by a section parallel to or almost parallel to the axial direction of the guide roller.

FIG. 9 is a schematic view showing the measurement results of the curved amount under the conditions of Examples 1 to 8 and Comparative Example 1, in verification related to the embodiment and the like.

### DETAILED DESCRIPTION

In a manufacturing method of an electrode structure of an embodiment, a belt-like member, in which the surface of a current collector is coated with an active material-containing layer and an uncoated region not coated with the active material-containing layer is formed in one of a pair of long edges along the longitudinal direction and its vicinity in the current collector, is conveyed. In this manufacturing method, the active material-containing layer is rolled, and the belt-like member is pulled toward the downstream side, on the downstream side of a rolling unit for rolling the active material-containing layer, thereby applying a tension in the longitudinal direction to the belt-like member between a pulling unit for pulling the belt-like member and the rolling unit. In the manufacturing method, the uncoated region of the current collector is pushed against the belt-like member to which the tension is applied, by a projection projecting to the outer peripheral side on a roller between the rolling unit and the pulling unit, thereby enlarging the uncoated region in the longitudinal direction. The uncoated region is pushed by the projection whose projection length to the projection end is larger than the thickness of the active material-containing layer rolled by the rolling unit.

The embodiment and the like will be explained below with reference to the accompanying drawings.

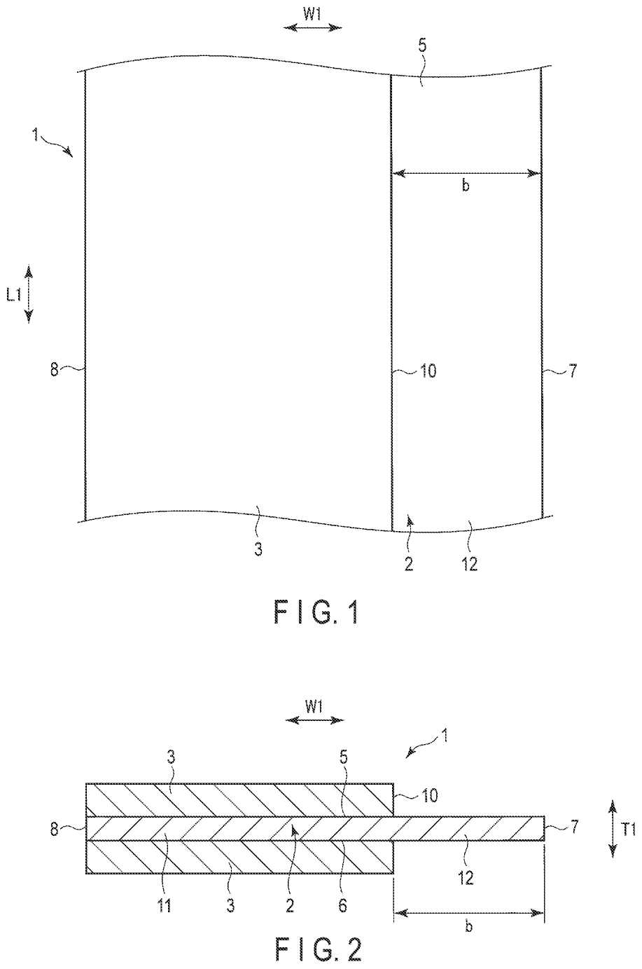

The embodiment provides a manufacturing method and a manufacturing apparatus of an electrode structure. An electrode structure manufactured in the embodiment is used in the formation of a positive electrode or a negative electrode in a battery such as a secondary battery. FIGS. 1 and 2 show an example of an electrode structure 1 manufactured in the embodiment. In the electrode structure 1 as shown in FIGS. 1 and 2, a longitudinal direction (a direction indicated by an arrow L1), a widthwise direction (a direction indicated by an arrow W1) crossing (perpendicular to or almost perpendicular to) the longitudinal direction, and a thickness direction (a direction indicated by an arrow Tl) crossing (perpendicular to or almost perpendicular to) both the longitudinal direction and the widthwise direction, are defined. FIG. 1 shows a state viewed from one side of the thickness direction, and FIG. 2 shows a section perpendicular to or almost perpendicular to the longitudinal direction. In the electrode structure 1, a dimension in the longitudinal direction is larger than dimensions in the widthwise direction and the thickness direction, and the dimension in the widthwise direction is larger than the dimension in the thickness direction.

In one example, the electrode structure 1 is used as the positive electrode or the negative electrode of a battery such as a lithium-ion secondary battery. In another example, the electrode structure 1 is divided into a plurality of electrode sheets in the longitudinal direction. Then, each of the plurality of electrode sheets is used as a positive electrode or a negative electrode. The electrode structure 1 includes a current collector 2, and active material-containing layers 3 applied on surfaces of the current collector 2. The current collector 2 is made of a metal having conductivity, and includes a pair of principal surfaces 5 and 6, and a pair of long edges 7 and 8. Each of the principal surfaces 5 and 6 and the long edges 7 and 8 is extended along the longitudinal direction, and extended from one end to the other end of the electrode structure 1 in the longitudinal direction. Also, each of the principal surfaces 5 and 6 is extended from the long edge 7 to the long edge 8 in the widthwise direction of the electrode structure 1. The principal surface 5 faces one side in the thickness direction of the electrode structure 1, and the principal surface 6 faces the side opposite to the principal surface 5 in the thickness direction of the electrode structure 1.

The long edge (first long edge) 7 forms an edge on one side of the current collector 2 in the widthwise direction of the electrode structure 1. The long edge (second long edge) 8 forms an edge on the side opposite to the long edge 7 of the current collector 2 in the widthwise direction of the electrode structure 1. The active material-containing layer 3 is extended from one end to the other end of the electrode structure 1 in the longitudinal direction. Also, the active material-containing layer 3 is extended from the long edge 8 of the current collector 2 to a coating end 10 in the widthwise direction of the electrode structure 1. The end opposite to the coating end 10 of the active material-containing layer 3 in the widthwise direction of the electrode structure 1 overlaps the long edge 8 of the current collector 2 when viewed in the thickness direction. The coating end 10 is positioned on a side where the long edge 7 is positioned, with respect to the central position of the electrode structure 1 in the widthwise direction. Accordingly, the dimension between the long edge 8 and the coating end 10 in the widthwise direction of the electrode structure 1 is larger than the dimension between the long edge 7 and the coating end 10 in the widthwise direction of the electrode structure 1.

In this example shown in FIGS. 1 and 2, a coated region 11 where the active material-containing layers 3 are applied on and supported by both of the pair of principal surfaces 5 and 6 of the current collector 2 is formed between the long edge 8 and the coating end 10 in the widthwise direction of the electrode structure 1. In addition, an uncoated region 12 where the active material-containing layer 3 is not coated on or supported by either of the pair of principal surfaces 5 and 6 of the current collector 2 is formed between the long edge 7 and the coating end 10 in the widthwise direction of the electrode structure 1. In the current collector 2, therefore, the uncoated region 12 where the active material-containing layer 3 is not formed on either of the pair of principal surfaces 5 and 6 is formed in the long edge 7 and its vicinity in the current collector 2. In the electrode structure 1, the uncoated region 12 protrudes from the coating end 10 of the active material-containing layer 3 to the side opposite to the side where the long edge 8 is positioned in the widthwise direction. Note that in one example, the active material-containing layer 3 is supported by only one of the pair of principal surfaces 5 and 6 of the current collector 2 in the coated region 11. In the coated region 11, therefore, the active material-containing layer 3 need only be applied on and supported by at least one of the pair of principal surfaces 5 and 6 of the current collector 2.

In a case where the electrode structure 1 is used to form a positive electrode, the current collector 2 is formed by one of, for example, aluminum, an aluminum alloy, stainless steel, and titanium, although the material is not limited to them, and has a thickness of about 10 μm to 30 μm. The active material-containing layer 3 includes a positive electrode active material, and can also include a binder and an electro-conductive agent. Examples of the positive electrode active material are an oxide, a sulfide, and a polymer, each of which can occlude and release lithium ions, although the material is not limited to them. The positive electrode active material includes, for example, at least one selected from the group consisting of a lithium-manganese composite oxide, a lithium-nickel composite oxide, a lithium-cobalt-aluminum composite oxide, a lithium-nickel-cobalt-manganese composite oxide, a spinel lithium-manganese-nickel composite oxide, a lithium-manganese-cobalt oxide, a lithium-iron oxide, lithium fluorinated iron sulfate, a lithium-iron composite phosphate compound, and a lithium-manganese composite phosphate compound.

One or more types of carbonaceous materials are used as the electro-conductive agent. Examples of the carbonaceous materials to be used as the electro-conductive agent are acetylene black, Ketjenblack, graphite, and coke. Also, a polymer resin or the like is used as the binder. The binder contains, for example, at least one selected from the group consisting of polytetrafluoroethylene (PTFE), polyvinylidene fluoride (PVdF), fluorine-based rubber, ethylene-butadiene rubber, polypropylene (PP), polyethylene (PE), carboxymethylcellulose (CMC), polyimide (PI), and polyacrylimide (PAI).

In a case where the electrode structure 1 is used to form a negative electrode, the current collector 2 is formed by one of, for example, zinc, aluminum, an aluminum alloy, and copper, although the material is not limited to them, and has a thickness of about 10 μm to 30 μm. The negative electrode active material-containing layer includes a negative electrode active material, and can also include a binder and an electro-conductive agent. The negative electrode active material is not particularly limited, and examples are a metal oxide, a metal sulfide, a metal nitride, and a carbonaceous material, each of which can occlude and release lithium ions. An example of the metal oxide usable as the negative electrode active material is a titanium-containing oxide. Examples of the titanium-containing oxide usable as the negative electrode active material are titanium oxide, lithium titanium oxide, niobium titanium oxide, and sodium niobium titanium oxide. Examples of the electro-conductive agent and the binder are the same materials as those used in the formation of the positive electrode.

In the manufacture of the electrode structure 1, the active material to be used as the positive electrode active material or the negative electrode active material, the electro-conductive agent, and the binder are suspended in an organic solvent, thereby preparing a slurry. In this case, the blending ratio of the active material is preferably 70 mass % (inclusive) to 95 mass % (inclusive), that of the electro-conductive agent is preferably 3 mass % (inclusive) to 20 mass % (inclusive), and that of the binder is preferably 2 mass % (inclusive) to 10 mass % (inclusive). The prepared slurry was applied on the surfaces of the current collector 2, thereby forming a belt-like member in which the surfaces of the current collector 2 are coated with active material-containing layers 3. Coating of the slurry is performed by using a coating head or the like.

In the manufacture of the electrode structure 1, the electrode structure 1 is formed by performing steps to be described later on the belt-like member formed as described above. In the belt-like member, the longitudinal direction, the widthwise direction, and the thickness direction are defined, and the coated region 11 and the uncoated region 12 are formed, in the same manner as in the electrode structure 1. In the belt-like member, therefore, the uncoated region 12 where neither of the pair of principal surfaces 5 and 6 is coated with the active material-containing layer 3 is formed in the long edge 7 and its vicinity in the current collector 2. Also, in the belt-like member, the coated region 11 where at least one of the pair of principal surfaces 5 and 6 is coated with the active material-containing layer 3 is formed from the long edge 8 of the current collector 2 to the coating end 10 of the active material-containing layer 3 in the widthwise direction. In the manufacture of the electrode structure 1, after the current collector 2 is coated with the active material-containing layers 3, the active material-containing layers 3 (slurry) applied on the surfaces of the current collector 2 are dried.

Depending on a battery that uses the electrode formed from the electrode structure 1, it is necessary to increase a dimension (width) b of the uncoated region 12 in the widthwise direction in the belt-like member. In one example, the current collector 2 is coated with the active material-containing layers 3 such that the dimension b of the uncoated region 12 in the widthwise direction of the belt-like member (current collector 2) becomes larger than 25 mm. In this case, in the manufactured electrode structure 1, the dimension b of the uncoated region 12 in the widthwise direction is larger than 25 mm. However, even in a case where the dimension b of the uncoated region 12 in the widthwise direction of the belt-like member is larger than 25 mm, the dimension of the coated region 11 in the widthwise direction is larger than the dimension b of the uncoated region 12 in the widthwise direction.

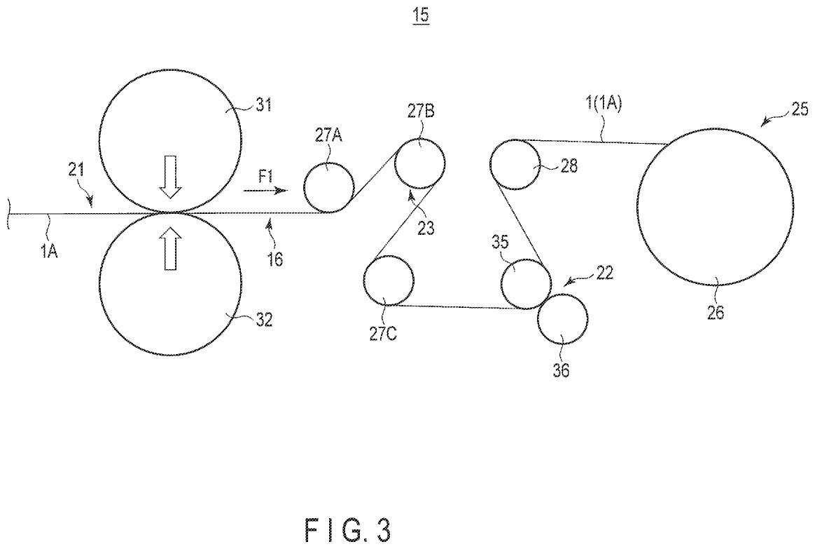

FIG. 3 shows an example of a manufacturing apparatus 15 for manufacturing the electrode structure 1. FIG. 3 shows a step after the active material-containing layers 3 applied on the current collector 2 are dried in the manufacture of the electrode structure 1. The manufacturing apparatus 15 in the example shown in FIG. 3 includes a conveyance unit 16. In the conveyance unit 16, a belt-like member 1A, in which the current collector 2 is coated with the active material-containing layers 3 and the applied active material-containing layers 3 are dried, is conveyed. In the conveyance unit 16, a conveyance direction (a direction indicated by an arrow F1) and a widthwise direction crossing (perpendicular to or almost perpendicular to) the conveyance direction are defined. Referring to FIG. 3, a direction perpendicular to or almost perpendicular to the paper surface is the widthwise direction of the conveyance unit 16. Also, in the conveyance unit 16, a side on which the belt-like member 1A is conveyed is the downstream side, and a side opposite to the side on which the belt-like member 1A is conveyed is the upstream side. In the conveyance unit 16, the belt-like member 1A is conveyed such that the longitudinal direction of the belt-like member 1A is taken along the conveyance direction, and the widthwise direction of the belt-like member 1A is taken along the widthwise direction of the conveyance unit 16. Accordingly, in the belt-like member 1A conveyed in the conveyance unit 16, the thickness direction of the belt-like member 1A crosses (is perpendicular to or almost perpendicular to) both the conveyance direction and the widthwise direction of the conveyance unit 16.

The manufacturing apparatus 15 of the example shown in FIG. 3 includes a rolling unit 21, a pulling unit 22, an enlarging unit 23, and a take-up unit 25. In the manufacturing apparatus 15, the belt-like member 1A in which the active material-containing layers 3 are dried is conveyed into the rolling unit 21. Then, the belt-like member 1A is conveyed from the rolling unit 21 to the take-up unit 25 by being passed through the enlarging unit 23 and the pulling unit 22 in this order. The rolling unit 21, the enlarging unit 23, and the pulling unit 22 perform steps to be described later on the conveyed belt-like member 1A, thereby forming the electrode structure 1. The take-up unit 25 takes up the conveyed belt-like member 1A, that is, the formed electrode structure 1. In this example shown in FIG. 3, the take-up unit 25 includes a take-up reel 26, and the take-up reel 26 takes up the electrode structure 1 (the belt-like member 1A) in the form of a roll. Also, in the example shown in FIG. 3, three guide rollers (rollers) 27A, 27B, and 27C guide the belt-like member 1A from the upstream side to the downstream side in the conveyance unit 16, between the rolling unit 21 and the pulling unit 22. In addition, a guide roller 28 guides the belt-like member 1A from the upstream side to the downstream side between the pulling unit 22 and the take-up unit 25. Each of the guide rollers 27A to 27C and 28 is made of a metal such as stainless steel.

The rolling unit 21 rolls the active material-containing layer 3 in the conveyed belt-like member 1A by using a roll press or the like. The rolling unit 21 includes a pair of press rollers 31 and 32, and each of the press rollers 31 and 32 is made of a metal such as stainless steel. The press roller 31 presses the active material-containing layer 3 from one side in the thickness direction of the belt-like member 1A, and the press roller 32 presses the active material-containing layer 3 from the side opposite to the press roller 31, in the thickness direction of the belt-like member 1A. Consequently, the active material-containing layer 3 is sandwiched between the press rollers 31 and 32 in the thickness direction of the belt-like member 1A, and a pressure (press pressure) is applied to the active material-containing layer 3 in the thickness direction of the belt-like member 1A. In a case where the both surfaces of the current collector 2 are coated with the active material-containing layers 3, the active material-containing layers 3 are pressed in a state in which the press rollers 31 and 32 are in contact with the active material-containing layers 3. In a case where only one surface of the current collector 2 is coated with the active material-containing layer 3, the active material-containing layer 3 is pressed in a state in which one of the press rollers 31 and 32 is in contact with the active material-containing layer 3, and the other one of the press rollers 31 and 32 is in contact with the coated region 11 of the current collector 2. The pressure from the press rollers 31 and 32 compresses the active material-containing layer 3 in the thickness direction of the belt-like member 1A, and enlarges the active material-containing layer 3 in the longitudinal direction of the belt-like member LA.

The pressure for rolling the active material-containing layer 3 is also applied to the coated region 11 coated with the active material-containing layer 3 on at least one of the pair of principal surfaces 5 and 6 in the current collector 2. In the coated region 11, therefore, the pressure for rolling the active material-containing layer 3 enlarges the current collector 2 in the longitudinal direction. On the other hand, the press rollers 31 and 32 do not apply any pressure for rolling the active material-containing layer 3 to the uncoated region 12 of the current collector 2. In the rolling of the active material-containing layer 3, therefore, the uncoated region 12 of the current collector 2 is not enlarged in the longitudinal direction. Since the current collector 2 is enlarged in the longitudinal direction in only the coated region 11 as described above, the rolling of the active material-containing layer 3 curves the conveyed belt-like member 1A (the current collector 2) in a state in which the side where the uncoated region 12 is positioned is the inside of the curve.

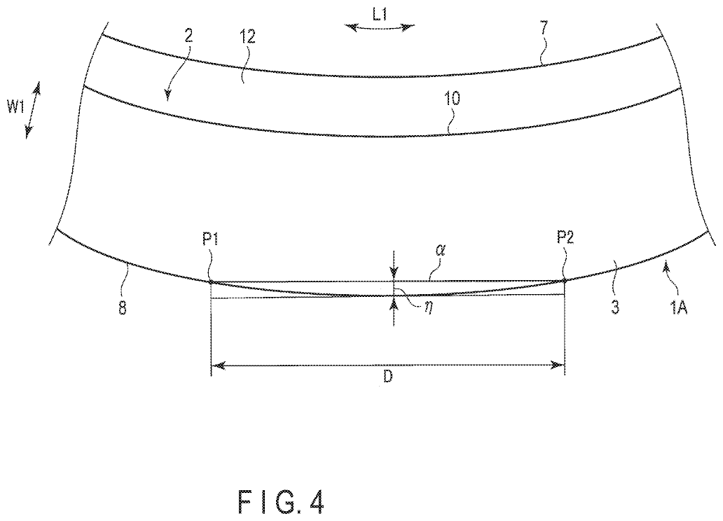

The curved amount of the belt-like member 1A in a state in which the belt-like member 1A is curved as described above can be measured. FIG. 4 shows an example of a measurement method of measuring the curved amount of the curved belt-like member 1A. In this example shown in FIG. 4, as described above, the rolling of the active material-containing layer 3 curves the conveyed belt-like member 1A (the current collector 2) such that the side where the uncoated region 12 is positioned is the inside of the curve. This measurement method of the example shown in FIG. 4 specifies two points P1 and P2 at a defined distance D as a straight-line distance, in the long edge 8 of the current collector 2, that is, in the end opposite to the coating end 10 of the active material-containing layer 3 in the widthwise direction of the belt-like member 1A. Then, a reference straight line α connecting the points P1 and P2 is defined, and a projection amount (projection dimension) of the long edge 8 (the end opposite to the coating end 10 of the active material-containing layer 3) from the reference straight line α to the outside of the curve is calculated as a curved amount η. That is, the distance from the reference straight line α to the projection end of the projecting portion of the long edge 8 is calculated as the curved amount η. The larger the curved amount η, the larger the curve of the belt-like member 1A.

In this embodiment, the pulling unit 22 and the enlarging unit 23 correct the curve of the belt-like member 1A (the current collector 2) produced by the rolling of the active material-containing layer 3. The pulling unit 22 is installed on the downstream side of the conveyance unit 16 with respect to the rolling unit 21, and pulls the belt-like member 1A toward the downstream side. That is, the pulling unit 22 pulls the belt-like member 1A to the side where the take-up unit 25 is positioned. The pulling unit 22 includes a pair of pulling rollers 35 and 36. Each of the pulling rollers 35 and 36 is made of rubber or the like, and the friction coefficient of the pulling rollers 35 and 36 is larger than those of the guide rollers 27A to 27C and 28 and the press rollers 31 and 32.

In the pulling unit 22, the pulling roller 35 abuts against the belt-like member 1A from one side in the thickness direction, and the pulling roller 36 abuts against the belt-like member 1A from the side opposite to the pulling roller 35 in the thickness direction. In the pulling unit 22, therefore, the belt-like member 1A is pulled to the downstream side of the conveyance unit 16 in a state in which the belt-like member 1A is sandwiched between the pulling rollers 35 and 36. Since the pulling unit 22 pulls the belt-like member 1A to the downstream side, a tension in the longitudinal direction is applied to the belt-like member 1A (the current collector 2) between the pulling unit 22 and the rolling unit 21. Between the pulling unit 22 and the roller unit 21, therefore, the belt-like member 1A to which the tension in the longitudinal direction is applied is conveyed through the guide rollers 27A to 27C.

The enlarging unit 23 is installed between the rolling unit 21 and the pulling unit 22 in the conveyance unit 16. In the example shown in FIG. 3, the guide roller 27B forms the enlarging unit 23. Note that the enlarging unit 23 is formed by the guide roller 27B in the following explanation, but the enlarging unit 23 can also be formed by one of the guide rollers 27A and 27C. That is, between the rolling unit 21 and the pulling unit 22, the enlarging unit 23 need only be formed by a roller, such as a guide roller, which is used to convey the belt-like member 1A. In either case, the configuration of the enlarging unit 23, the processing by the enlarging unit 23, and the like are the same as in a case where the enlarging unit 23 is formed by the guide roller 27B.

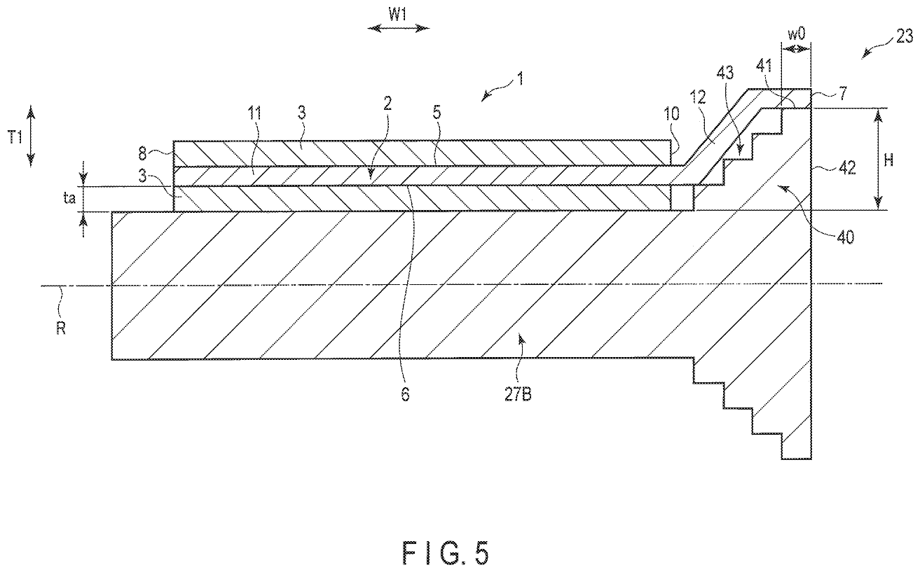

FIG. 5 shows an example of the configuration of the enlarging unit 23. FIG. 5 shows the belt-like member 1A by a section perpendicular to or almost perpendicular to the longitudinal direction. In this example shown in FIG. 5, the enlarging unit 23 includes the guide roller (roller) 27B, and the guide roller 27B has a rotational axis (central axis) R. The guide roller 27B can rotate around the rotational axis R. In the guide roller 27B, an axial direction taken along the rotational axis R and a circumferential direction as a direction around the rotational axis R are defined. In the conveyance unit 16, the belt-like member 1A is conveyed in a state in which the rotational axis R of the guide roller 27B is taken along the widthwise direction of the belt-like member 1A. Accordingly, the axial direction of the guide roller 27B matches or almost matches the widthwise direction of the conveyance unit 16.

The enlarging unit 23 includes a projection 40 formed on the outer peripheral portion of the guide roller 27B. On the outer peripheral portion of the guide roller 27B, the projection 40 projects toward the outer peripheral side. Also, the projection 40 is formed over the entire circumference in the circumferential direction of the guide roller 27B (the direction around the rotational axis R). In the guide roller 27B, the projection 40 is formed in one end portion in the axial direction. Note that FIG. 5 shows the guide roller 27B by a section parallel to or almost parallel to the axial direction (the rotational axis R).

In a state in which the belt-like member LA is conveyed through the guide roller 27B, the projection 40 is formed on a side where the long edge 7 is positioned, with respect to the coating end 10 of the active material-containing layer 3, in the widthwise direction of the belt-like member 1A. That is, the projection 40 is positioned on a side where the uncoated region 12 projects, with respect to the coating end 10 of the active material-containing layer 3, in the axial direction of the guide roller 27B. The projection 40 abuts against the uncoated region 12 of the current collector 2, from one side in the thickness direction, in the belt-like member 1A to which a tension is applied in the longitudinal direction by the pulling unit 22, and pushes the uncoated region 23 from one side in the thickness direction. Since the uncoated region 12 is pushed by the projection 40 with the tension being applied, the current collector 2 in the uncoated region 12 is enlarged (extended) in the longitudinal direction by the pressure from the projection 40.

In a state in which the belt-like member 1A is conveyed through the extending unit 23, as described above, the projection 40 is positioned on a side where the uncoated region 12 projects toward the coating end 10 of the active material-containing layer 3, in the widthwise direction of the belt-like member 1A. Accordingly, the projection 40 does not abut against the active material-containing layer 3 and the coated region 11 of the current collector 2, and does not push the coated region 11 of the current collector 2. In the enlarging unit 23, therefore, the coated region 11 of the current collector 2 is not enlarged in the longitudinal direction.

In this embodiment as described above, the current collector 2 is enlarged in the longitudinal direction in only the uncoated region 12 by pushing only the uncoated region 12 by the projection 40 in a state in which the tension in the longitudinal direction acts on the belt-like member 1A (the current collector 2). Since the current collector 2 is enlarged in the longitudinal direction in only the uncoated region 12, the above-described curve produced by the rolling of the active material-containing layer 3 is corrected. Note that in a case where only one of the pair of principal surfaces 5 and 6 is coated with the active material-containing layer 3 in the coated region 11, the projection 40 pushes the uncoated region 12 from a side toward which the principal surface (a corresponding one of 5 and 6) to be coated with the active material-containing layer 3 faces, in the thickness direction of the belt-like member 1A.

The projection 40 includes a projection end, and a projection length H to the projection end is defined in the projection 40. The projection 40 also includes a projection end face 41 forming the projection end. In the projection 40, the distance from the root position of the projection to the projection end face 41 is the projection length H. The projection end face 41 is formed over the entire circumference in the circumferential direction of the guide roller 27B. In this embodiment, the projection length H of the projection 40 is larger than a thickness ta of the active material-containing layer 3 rolled by the rolling unit 21. In a case where the active material-containing layers 3 are formed on both of the pair of principal surfaces 5 and 6 in the coated region 11 as in the example shown in FIG. 5, the projection length H of the projection 40 is larger than the thickness of the active material-containing layer 3 applied on the principal surface 5, and the thickness of the active material-containing layer 3 applied on the principal surface 6. Also, the projection length H of the projection 40 is preferably twice or more to 15 times or less the thickness ta of the active material-containing layer 3.

In the projection 40, a projection side surface 42 forms one end of the projection 40 in the axial direction of the guide roller 27B. The projection side surface 42 is formed over the entire circumference in the circumferential direction of the guide roller 27B. In the example shown in FIG. 5, the projection side surface 42 is extended along the radial direction of the guide roller 27B, and faces the outside in the axial direction of the guide roller 27B. In a state in which the belt-like member 1A is conveyed through the guide roller 27B, the projection side surface 42 faces the side on which the uncoated region 12 projects, and faces the side opposite to the side where the active material-containing layer 3 is positioned, in the widthwise direction of the belt-like member 1A.

The projection end face 41 is extended from the projection side surface 42 along the axial direction of the guide roller 27B. In a state in which the belt-like member 1A is conveyed through the guide roller 27B, the projection end face 41 is extended from the projection side surface 42 toward the side where the active material-containing layer 3 is positioned in the widthwise direction of the belt-like member 1A. The projection end face 41 is formed over a predetermined width w0 in the axial direction of the guide roller 27B. The predetermined width w0 of the projection end face 41 is preferably larger than 0 mm, and 15 mm or less.

In the projection 40, a projection amount changing portion 43 is formed adjacent to the projection end face 41 from one side in the axial direction of the guide roller 27B. The projection amount changing portion 43 is adjacent to the projection end face 41 from the side opposite to the side where the projection side surface 42 is positioned in the axial direction of the guide roller 27B. The projection amount changing portion 43 is formed over the entire circumference in the circumferential direction of the guide roller 27B. In the projection amount changing portion 43, the projection amount on the outer peripheral surface of the guide roller 27B reduces in the direction away from the projection end face 41 in the axial direction of the guide roller 27B. In the projection amount changing portion 43, the projection amount reduces toward the side opposite to the side where the projection side surface 42 is positioned in the axial direction of the guide roller 27B.

In a state in which the belt-like member 1A is conveyed through the guide roller 27B, that is, in a state in which the projection 40 pushes the uncoated region 12 of the current collector 2, the projection amount changing portion 43 is positioned between the projection end face 41 of the projection 40 and the active material-containing layer 3, in the widthwise direction of the belt-like member 1A. In a state in which the projection 40 pushes the uncoated region 12 of the current collector 2, the projection amount in the projection amount changing portion 43 reduces toward the side where the active material-containing layer 3 is positioned in the widthwise direction of the belt-like member 1A. In the projection amount changing portion 43, the projection amount reduces to 0 from the projection length H of the projection 40 as the projection amount on the projection end face 41.

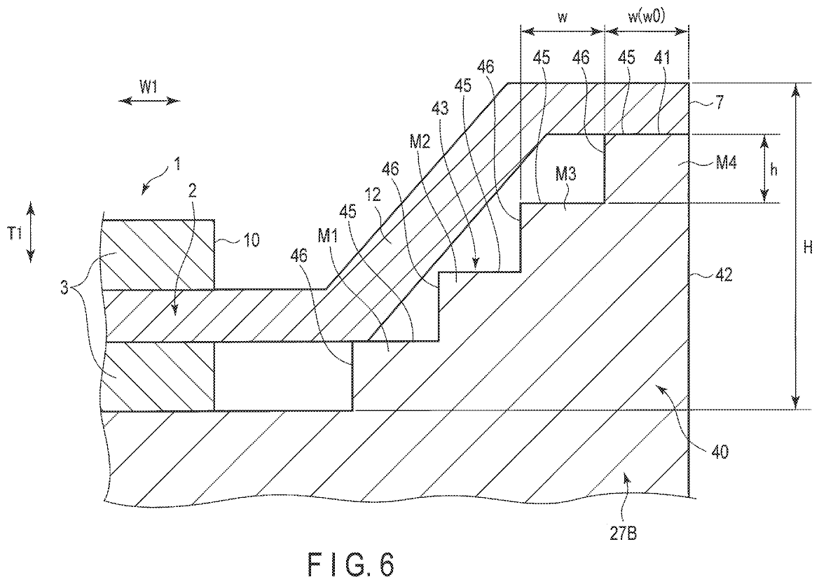

FIG. 6 shows the projection 40 and its vicinity on the guide roller 27B configuring the enlarging unit 23. FIG. 6 shows a state in which the projection 40 pushes the uncoated region 12 of the current collector 2. Also, FIG. 6 shows the belt-like member 1A by a section perpendicular to or almost perpendicular to the longitudinal direction, and shows the guide roller 27B by a section parallel to or almost parallel to the rotational axis R. The projection 40 of this embodiment is formed into a multi-step projecting structure, and includes a plurality of steps M. In the example shown in FIGS. 5 and 6, four steps M1 to M4 are formed in the projection 40. Note that a case where the four steps M1 to M4 are formed will be explained below, but the configuration of the projection 40 to be explained below is also applicable to a case where the number of steps M formed in the projection 40 is 2 or 3, and to a case where the number of steps M formed in the projection 40 is 5 or more.

Each of the steps M1 to M4 is formed over the entire circumference in the circumferential direction of the guide roller 27B. The four steps M1 to M4 are formed in the order of the steps M1, M2, M3, and M4 from the inner peripheral side to the outer peripheral side of the guide roller 27B. The projection amounts of the steps M1 to M4 increase toward the outer peripheral side of the guide roller 27B. The step M4 on the most outer peripheral side of the steps M1 to M4 forms the projection end face 41 of the projection 40. Therefore, the projection amount of the step M4 on the most outer peripheral side is the projection length H of the projection 40. To each of the steps M2 to M4 except for the step M1 on the most inner peripheral side, a step on a one-step inner peripheral side is adjacent from the side opposite to the side where the projection side surface 42 is positioned in the axial direction of the guide roller 27B. In the step M4, for example, the step M3 is adjacent from the side opposite to the side where the projection side surface 42 is positioned in the axial direction of the guide roller 27B. In addition, of the steps M1 to M3, a step on an inner peripheral is positioned away from the step M4 on the most outer peripheral side in the axial direction of the guide roller 27B.

In a state in which the projection 40 pushes the uncoated region 12 of the current collector 2, a step on a one-step inner peripheral side is adjacent to each of the steps M2 to M4 from the side where the active material-containing layer 3 is positioned in the widthwise direction of the belt-like member 1A. Also, in this state in which the projection 40 pushes the uncoated region 12 of the current collector 2, a step on an inner peripheral of the steps M1 to M4 is positioned closer to the active material-containing layer 3 (the coating end 10) in the widthwise direction of the belt-like member 1A (the axial direction of the guide roller 27B). Of the steps M1 to M4, therefore, the step M1 is positioned closest to the active material-containing layer 3 in the widthwise direction of the belt-like member 1A, and the step M4 is positioned farthest from the active material-containing layer 3 in the widthwise direction of the belt-like member 1A.

Each of the steps M1 to M4 includes an extension surface (outer peripheral surface) 45 and a step height formation surface 46. In each of the steps M1 to M4, the extension surface 45 and the step height formation surface 46 are formed over the entire circumference in the circumferential direction of the guide roller 27B. The extension surface 45 of each of the steps M1 to M4 faces the outer peripheral side of the guide roller 27B. In the projection 40, the extension surface 45 of the step M4 on the most outer peripheral side is the projection end face 41. The extension surface 45 of each of the steps M1 to M4 is extended along the axial direction of the guide roller 27B.

Also, the step height formation surface 46 of each of the steps M1 to M4 faces the side opposite to the side where the projection side surface 42 is positioned, in the axial direction of the guide roller 27B. In a state in which the projection 40 pushes the uncoated region 12 of the current collector 2, the step height formation surface 46 of each of the steps M1 to M4 faces the side where the active material-containing layer 3 is positioned, in the widthwise direction of the belt-like member 1A. In each of the steps M1 to M4, the step height formation surface 46 is extended along the radial direction of the guide roller 27B, and the outer peripheral end of the step height formation surface 46 is connected to the extension surface 45. Also, in each of the steps M2 to M4 except for the step M1 on the most inner peripheral side, the inner peripheral end of the step height formation surface 46 is connected to the extension surface 45 of a step on a one-step inner peripheral side. In the step M1, the inner peripheral end of the step height formation surface 46 is positioned in the root position of the projection 40. The step height formation surface 46 of each of the steps M2 to M4 forms a step height h with respect to a step on a one-step inner peripheral side. The step height formation surface 46 of the step M1 forms the step height h with respect to the root position of the projection 40.

The step heights h of the steps M1 to M4 can be either the same as each other or different from each other. However, the step height h of each of the steps M1 to M4 is preferably larger than one-fold, and five-fold or less, of the thickness to of the rolled active material-containing layer 3.

In this embodiment, the step height formation surface 46 of the step M4 on the most outer peripheral side and the steps M1 to M3 except for the step M4 on the most outer peripheral side form the projection amount changing portion 43. In the projection amount changing portion 43, the projection amount changes on the step height formation surface 46 of each of the steps M1 to M4 by the same change amount as the step height h formed by the step height formation surface 46. In the projection amount changing portion 43, therefore, the projection amount on the outer peripheral surface of the guide roller 27B reduces stepwise in the direction away from the projection end face 41 and the projection side surface 42 in the axial direction of the guide roller 27B. In a state in which the projection 40 pushes the uncoated region 12 of the current collector 2, the projection amount in the projection amount changing portion 43 reduces stepwise toward the side where the active material-containing layer 3 is positioned, in the widthwise direction of the belt-like member 1A. That is, in the projection amount changing portion 43, the projection amount reduces on the step height formation surface 46 of each of the steps M1 to M4 toward the side where the active material-containing layer 3 is positioned, in the widthwise direction of the belt-like member 1A.

Each of the steps M1 to M4 is formed over a width w in the axial direction of the guide roller 27B (the widthwise direction of the belt-like member 1A in a state in which the belt-like member 1A is conveyed). The width w of the step M4 on the most outer peripheral side is the predetermined width w0 of the projection end face 41 described earlier. The widths w of the steps M1 to M4 can be either the same as each other or different from each other. However, the width w of each of the steps M1 to M4 is preferably larger than 0 mm, and 15 mm or less, like the predetermined width w0 of the projection end face 41. In this embodiment as described above, in the projection 40 that pushes the uncoated region 12 of the current collector 2, the projection length H to the projection end is larger than the thickness to of the active material-containing layer 3 rolled by the rolling unit 21. Accordingly, even if the dimension b of the uncoated region 12 is large in the widthwise direction of the current collector 2 in the belt-like member 1A, the uncoated region 12 is appropriately enlarged in the longitudinal direction in a state in which the projection 40 pushes the uncoated region 12 of the current collector 2 against the belt-like member 1A to which a tension is applied in the longitudinal direction. Consequently, even in the belt-like member 1A in which the dimension b of the uncoated region 12 is large in the widthwise direction of the current collector 2, such as the belt-like member 1A in which the dimension b is larger than 25 mm, the curve of the belt-like member 1A produced by rolling of the active material-containing layer 3 is properly corrected.

Also, by setting the projection length H of the projection 40 to twice (200%) or more the thickness ta of the rolled active material-containing layer 3, the uncoated region 12 is further properly enlarged by pushing from the projection 40. This further appropriately corrects the curve of the belt-like member 1A produced by rolling of the active material-containing layer 3. In addition, by setting the projection length H of the projection 40 to 15 times (1,500%) or less the thickness ta of the rolled active material-containing layer 3, a damage or the like to the uncoated region 12 of the current collector 2 caused by pushing of the projection 40 is effectively prevented.

Also, the projection end face 41 and the projection amount changing portion 43 are formed in the projection 40 of this embodiment as described above. In a state in which the projection 40 pushes the uncoated region 12 of the current collector 2, the projection amount changing portion 43 is positioned between the projection end face 41 and the active material-containing layer 3 in the widthwise direction of the belt-like member 1A, and, in the projection amount changing portion 43, the projection amount reduces toward the side where the active material-containing layer 3 is positioned in the widthwise direction of the belt-like member 1A. By pushing the uncoated region 12 as described above by the projection 40 including the projection end face 41 and the projection amount changing portion 43, the uncoated region 12 is further adequately enlarged in the longitudinal direction. This further adequately corrects the curve of the belt-like member 1A produced by rolling of the active material-containing layer 3. In addition, in this embodiment and the like, the predetermined width w0 of the projection end face 41 in the axial direction of the guide roller 27B is set at 15 mm or less. This further appropriately enlarges the uncoated region 12 in the longitudinal direction.

In this embodiment, the steps M1 to M4 are formed in the projection 40 as described above, and the step M4 on the most outer peripheral side among the steps M1 to M4 forms the projection end face 41. In the projection amount changing portion 43 of the projection 40, the step heights formed by the steps M1 to M4 reduce the projection amount stepwise toward the side away from the projection end face 41 in the axial direction of the guide roller 27B. In this embodiment as described above, the plurality of steps M1 to M4 are formed, so the step heights h of the steps M1 to M4 properly form the projection amount changing portion 43 in the projection 40.

Also, by setting the step height h of each of the steps M1 to M4 to be larger than one-fold (100%) of the thickness to of the rolled active material-containing layer 3, the uncoated region 12 is further appropriately enlarged in the longitudinal direction by pushing from the projection 40. This further appropriately corrects the curve of the belt-like member 1A produced by rolling of the active material-containing layer 3. In addition, by setting the step height h of each of the steps M1 to M4 to five times or less (500% or less) the thickness to of the rolled active material-containing layer 3, a damage or the like to the uncoated region 12 of the current collector 2 caused by pushing of the projection 40 is effectively prevented. Furthermore, by setting the width w of each of the steps M1 to M4 in the axial direction of the guide roller 27B to 15 mm or less, the uncoated region 12 is further properly enlarged in the longitudinal direction.

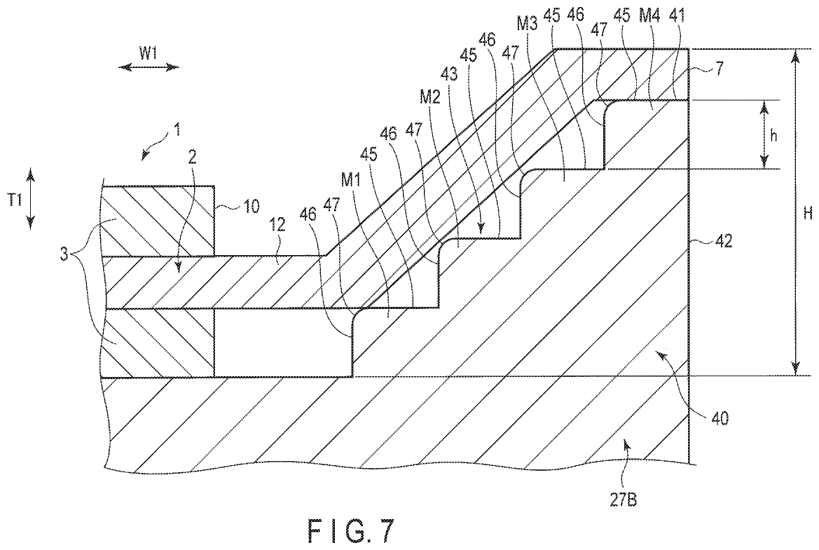

In a modification shown in FIG. 7, the plurality of steps M1 to M4 are formed in the projection 40. In this modification, a curved surface (chamfered portion) 47 is formed between the extension surface (outer peripheral surface) 45 and the step height formation surface 46 in each of the steps M1 to M4. In each of the steps M1 to M4, the curved surfaced 47 is formed over the entire circumference in the circumferential direction of the guide roller 27B (the direction around the rotational axis R). Note that FIG. 7 shows the projection 40 and its vicinity in the guide roller 27B configuring the enlarging unit 23. FIG. 7 shows a state in which the projection 40 pushes the uncoated region 12 of the current collector 2. Also, FIG. 7 shows the belt-like member 1A by a section perpendicular to or almost perpendicular to the longitudinal direction, and shows the guide roller 27B by a section parallel to or almost parallel to the rotational axis R.

As shown in FIG. 7, in the section parallel to or almost parallel to the rotational axis R, the curved surface 47 of each of the steps M1 to M4 takes an arc shape or an almost arc shape. The center of the arc shape or the almost arc shape of the curved surface 47 of each of the steps M1 to M4 is positioned on the side where the projection side surface 42 is positioned and on the inner peripheral side of the guide roller 27B, with respect to the curved surface 47. Also, a curvature radius r of the curved surface 47 of each of the steps M1 to M4 is preferably 0.5 mm (inclusive) to 7 mm (inclusive).

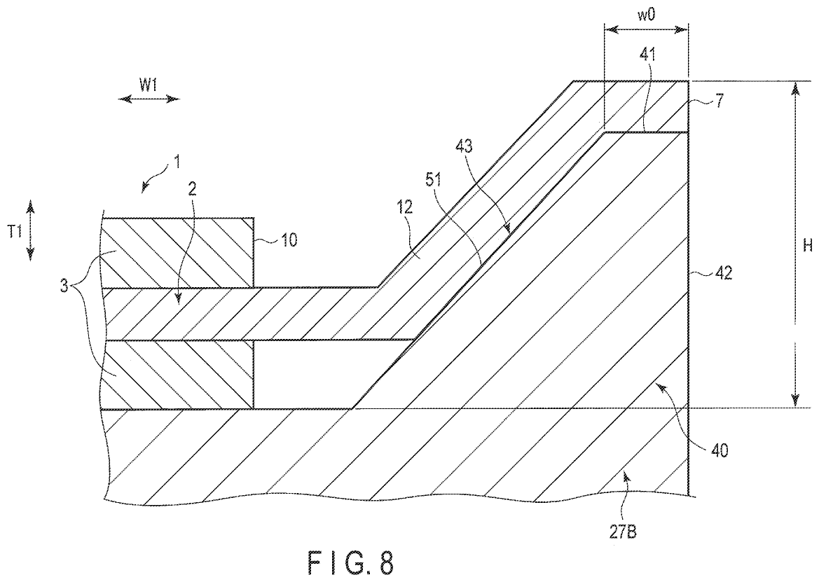

This modification achieves the same function and effect as those of the above-described embodiment and the like. That is, even in the belt-like member 1A in which the dimension b of the uncoated region 12 in the widthwise direction of the current collector 2 is large, the curve of the belt-like member 1A produced by rolling of the active material-containing layer 3 is adequately corrected. Also, in this modification, by setting the curvature radius r of the curved surface 47 of each of the steps M1 to M4 to 7 mm or less, the uncoated region 12 is further properly enlarged in the longitudinal direction by pushing from the projection 40. This further adequately corrects the curve of the belt-like member 1A produced by rolling of the active material-containing layer 3. In addition, by setting the curvature radius r of the curved surface 47 of each of the steps M1 to M4 to 0.5 mm or more, a damage or the like to the uncoated region 12 of the current collector 2 caused by pushing of the projection 40 is effectively prevented. In another modification shown in FIG. 8, the projection 40 has a single-step projecting structure instead of the multi-step projecting structure. FIG. 8 shows the projection 40 and its vicinity in the guide roller 27B configuring the enlarging unit 23. Also, FIG. 8 shows a state in which the projection 40 pushes the uncoated region 12 of the current collector 2. In addition, FIG. 8 shows the belt-like member 1A by a section perpendicular to or almost perpendicular to the longitudinal direction, and the guide roller 27B by a section parallel to or almost parallel to the rotational axis R.

As shown in FIG. 8, the projection length H to the projection end (the projection end face 41) of the projection 40 is larger than the thickness ta of the active material-containing layer 3 rolled by the rolling unit 21, in this modification as well. Als, the projection length H of the projection 40 is preferably twice or more and 15 times or less the thickness ta of the active material-containing layer 3. As in the embodiment described above, the projection end face 41 and the projection amount changing portion 43 are formed in the projection 40 in this modification as well. The projection end face 41 is formed over the predetermined width w0 in the axial direction of the guide roller 27B, and the predetermined width w0 of the projection end face 41 is preferably larger than 0 mm, and 15 mm or less.

In this modification, however, the projection amount changing portion 43 of the projection 40 is formed by an inclined surface 51. The inclined surface 51 is formed over the entire circumference in the circumferential direction of the guide roller 27B. Also, the inclined surface 51 inclines to both the axial direction of the guide roller 27B, and the radial direction of the guide roller 27B. In the projection amount changing portion 43, the inclined surface 51 reduces the projection amount in the form of a slope on the outer peripheral surface of the guide roller 27B, in the direction away from the projection end face 41 and the projection side surface 42 in the axial direction of the guide roller 27B. In a state in which the projection 40 pushes the uncoated region 12 of the current collector 2, the projection amount in the projection amount changing portion 43 reduces in the form of a slope toward the side where the active material-containing layer 3 is positioned in the widthwise direction of the belt-like member 1A. In the projection amount changing portion 43, the projection amount reduces to 0 from the projection length H of the projection 40 as the projection amount on the projection end face 41, in this modification as well. In still another modification, the projection amount changing portion 43 formed by the steps M1 to M4, the inclined surface 51, or the like is not formed in the projection 40. The projection length H to the projection end (the projection end face 41) of the projection 40 is larger than the thickness ta of the active material-containing layer 3 rolled by the rolling unit 21, in this modification as well. Also, the projection length H of the projection 40 is preferably twice or more and 15 times or less the thickness ta of the active material-containing layer 3. In addition, the projection end face 41 is formed in the projection 40 over the predetermined width w0 in the axial direction of the guide roller 27B, and the predetermined width w0 of the projection end face 41 is preferably larger than 0 mm, and 15 mm or less.

In all the modifications described above, the projection length H to the projection end (the projection end face 41) of the projection 40 is larger than the thickness ta of the active material-containing layer 3 rolled by the rolling unit 21. Accordingly, any of these modifications achieves the same function and effect as those of the above-described embodiment and the like. That is, even in the belt-like member 1A in which the dimension b of the uncoated region 12 in the widthwise direction of the current collector 2 is large, the curve of the belt-like member 1A produced by rolling of the active material-containing layer 3 is appropriately corrected.

### (Verification Related to Embodiment)

Verification related to the above-described embodiment was conducted. The conducted verification will be explained below. In this verification, a belt-like member was formed by coating the surfaces of a current collector with active material-containing layers. An aluminum foil was used as the current collector. To coat the surfaces of the current collector, a slurry was prepared by suspending an active material, an electro-conductive agent, and a binder in an organic solvent. An LiNi_{0.5}Co_{0.2}Mn_{0.3}O₂ composite oxide in which the average particle size of primary particles was 2 μm was used as the active material, graphite powder was used as the electro-conductive agent, and polyvinylidene fluoride (PVdF) was used as the binder. Also, an N-methyl-2-pyrrolidone (NMP) solvent was used as the organic solvent. In the preparation of the slurry, the blending ratios of the active material, the electro-conductive agent, and the binder were respectively 90 mass %, 5 mass %, and 5 mass %. The prepared slurry was applied on the surfaces of the current collector. More specifically, the slurry was not applied on one of the pair of long edges and its vicinity in the current collector. In the belt-like member, therefore, a coated region in which both of the pair of principal surfaces were coated with the active material-containing layers and an uncoated region in which neither of the pair of principal surfaces was coated with any active material-containing layer were formed. The uncoated region was formed in one of the pair of long edges and its vicinity in the current collector.

In this verification, after the belt-like member was formed as described above, the active material-containing layer (slurry) formed on the surface of the current collector was dried. Then, the belt-like member was conveyed as described earlier in the embodiment and the like in a conveyance unit similar to that of the example shown in FIG. 3. Subsequently, the active material-containing layer in the conveyed belt-like member was rolled by a roll press by using a rolling unit similar to that of the example shown in FIG. 3. Also, on the downstream side of the rolling unit, the belt-like member was pulled toward the downstream side by a pulling unit similar to that of the example shown in FIG. 3. This applied a tension in the longitudinal direction to the belt-like member between the pulling unit and the rolling unit. In the verification, a projection was formed on the outer peripheral surface of a roller equivalent to the guide roller 27B of the example shown in FIG. 3. The projection and the roller on the outer peripheral surface of which the projection was formed were formed from stainless steel. Then, as described previously in the embodiment and the like, the uncoated region of the current collector of the belt-like member to which the tension was applied was pushed by the projection, thereby enlarging the uncoated region in the longitudinal direction.

In the verification, after the uncoated region was enlarged by the projection, the curved amount η of the belt-like member was measured by the measurement method of the example shown in FIG. 4. In this measurement, the above-described defined distance D was set at 1,000 mm, and the two points P1 and P2 at the defined distance D as a straight-line distance were specified in the long edge on the side opposite to the uncoated region of the current collector.

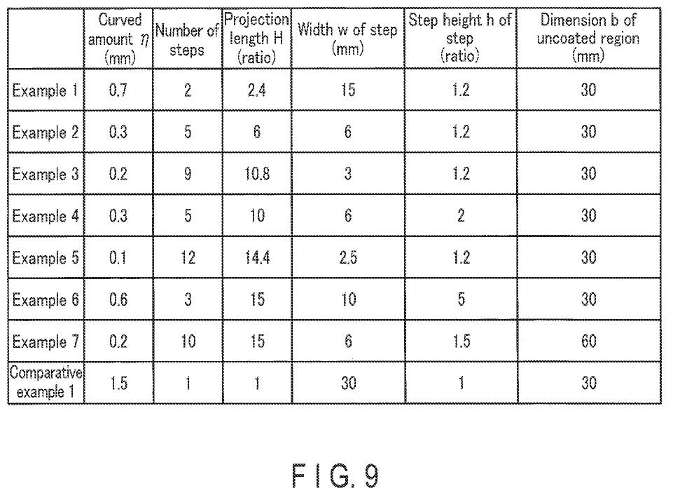

In the verification, the above-described process including enlarging of the uncoated region by the projection was performed under the conditions of Examples 1 to 7 and Comparative Example 1 to be explained below, and the curved amount η of the belt-like member was measured. Note that in Examples 1 to 7 and Comparative Example 1, the pressure (press pressure) for pressing the active material-containing layer in the rolling unit, the pulling force for pulling the belt-like member toward the downstream side in the pulling unit, and the like were the same as each other. FIG. 9 shows the conditions and the measurement results of the curved amount η of Examples 1 to 7 and Comparative Example 1, in the verification related to the embodiment and the like.

As shown in FIG. 9, in Examples 1 to 7, a projection was formed as a multi-step projecting structure including a plurality of steps, in the same manner as in the example shown in FIGS. 5 and 6. In Example 1, the projection length H of the projection to the projection end (projection end face) was 2.4 times the thickness ta of the rolled active material-containing layer. The number of steps in the projection was 2, and the width w of each step was 15 mm. Accordingly, the predetermined width w0 of the projection end face equivalent to the width w of the step on the most outer peripheral side was 15 mm. Also, the step height h of each step was 1.2 times the thickness ta of the rolled active material-containing layer. In addition, in the belt-like member, the dimension of the uncoated region in the widthwise direction of the belt-like member was 30 mm.

In Example 2, the projection length H was 6 times the thickness ta, the number of steps was 5, the width w was 6 mm, the step height h was 1.2 times the thickness ta, and the dimension b was 30 mm. In Example 3, the projection length H was 10.8 times the thickness ta, the number of steps was 9, the width w was 3 mm, the step height h was 1.2 times the thickness ta, and the dimension b was 30 mm. In Example 4, the projection length H was 10 times the thickness ta, the number of steps was 5, the width w was 6 mm, the step height h was 2 times the thickness ta, and the dimension b was 30 mm. In Example 5, the projection length H was 14.4 times the thickness ta, the number of steps was 12, the width w was 2.5 mm, the step height h was 1.2 times the thickness ta, and the dimension b was 30 mm. In Example 6, the projection length H was 15 times the thickness ta, the number of steps was 3, the width w was 10 mm, the step height h was 5 times the thickness ta, and the dimension b was 30 mm. In Example 7, the projection length H was 15 times the thickness ta, the number of steps was 10, the width w was 6 mm, the step height h was 1.5 times the thickness ta, and the dimension b was 60 mm.

In Comparative Example 1, a projection was formed as a single-step projecting structure. Therefore, the number of steps was 1. Also, a portion corresponding to the projection amount changing portion 43 of the above-described embodiment was not formed in the projection. In addition, the projection length H of the projection to the projection end (projection end face) was one-fold of the thickness ta of the rolled active material-containing layer. In Comparative Example 1, the number of steps was 1, so the projection length H was one-fold of the thickness ta, and the step height h of the step was one-fold of the thickness ta. Also, the width w of the step was 30 mm. In Comparative Example 1, the width w of the step was equivalent to the predetermined width w0 of the projection end face, so the predetermined width w0 of the projection end face was 30 mm because the width w was 30 mm. In addition, in the belt-like member, the dimension b of the uncoated region in the widthwise direction of the belt-like member was 30 mm.

The curved amount h of the belt-like member after the uncoated region was enlarged in the longitudinal direction by the projection was 0.7 mm in Example 1, 0.3 mm in Example 2, 0.2 mm in Example 3, 0.3 mm in Example 4, 0.1 mm in Example 5, 0.6 mm in Example 6, 0.2 mm in Example 7, and 1.5 mm in Comparative Example 1. In each of Examples 1 to 7, the curved amount η was smaller than that of Comparative Example 1. This demonstrates that when compared to a case where the projection length H of the projection was one-fold or less of the thickness ta of the rolled active material-containing layer 3, the curve of the belt-like member produced by rolling of the active material-containing layer is appropriately corrected by making the projection length H larger than the thickness ta of the active material-containing layer 3.

According to at least one embodiment or one example described above, a tension in the longitudinal direction is applied to the belt-like member between the rolling unit configured to roll the active material-containing layer and the pulling unit configured to pull the belt-like member. Then, the uncoated region of the current collector is pushed by the projection projecting toward the outer peripheral side on the roller between the rolling unit and the pulling unit, thereby enlarging the uncoated region in the longitudinal direction. The projection length of the projection to the projection end is larger than the thickness of the rolled active material-containing layer. This makes it possible to provide a manufacturing method and a manufacturing apparatus of an electrode structure that appropriately correct the curve of the belt-like member produced by rolling of the active material-containing layer, even if the dimension of the uncoated region increases in the widthwise direction of the current collector.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing method of an electrode structure comprising:
conveying a belt-like member in which a surface of a current collector is coated with an active material-containing layer, and an uncoated region not coated with the active material-containing layer is formed in one of a pair of long edges along a longitudinal direction and a vicinity thereof in the current collector;
rolling the active material-containing layer in the conveyed belt-like member;
pulling the belt-like member toward a downstream side, on the downstream side of a rolling unit configured to roll the active material-containing layer, thereby applying a tension in the longitudinal direction to the belt-like member between a pulling unit configured to pull the belt-like member and the rolling unit; and
enlarging the uncoated region of the current collector in the longitudinal direction by pushing the uncoated region against the belt-like member to which the tension is applied, by a projection projecting toward an outer peripheral side on a roller between the rolling unit and the pulling unit, the uncoated region being pushed by the projection in which a projection length to a projection end is larger than a thickness of the active material-containing layer rolled by the rolling unit.

2. The method according to claim 1, wherein
the belt-like member is conveyed in a state in which a rotational axis of the roller is taken along a widthwise direction of the belt-like member,
in the projection, a projection end face as the projection end is formed over a predetermined width in an axial direction along the rotational axis of the roller,
in the projection, a projection amount changing portion, in which a projection amount reduces in a direction away from the projection end face in the axial direction of the roller, is formed adjacent to the projection end face from one side in the axial direction, and
in a state in which the projection pushes the uncoated region of the current collector, the projection amount changing portion is positioned between the projection end face of the projection and the active material-containing layer in the widthwise direction of the belt-like member, and the projection amount in the projection amount changing portion reduces toward a side where the active material-containing layer is positioned in the widthwise direction of the belt-like member.

3. The method according to claim 2, wherein
a plurality of steps are formed in the projection such that a step on an outer peripheral side of the roller has a larger projection amount, and
in the projection, a step on a most outer peripheral side of the plurality of steps forms the projection end face, and the projection amount in the projection amount changing portion of the projection reduces stepwise in a direction away from the projection end face in the axial direction of the roller, due to a step height formed by each of the plurality of steps.

4. The method according to claim 3, wherein in the projection, the step height formed by each of the plurality of steps is larger than one-fold and not more than five-fold of the thickness of the rolled active material-containing layer.

5. The method according to claim 2, wherein in the projection, the predetermined width of the projection end face is larger than 0 mm and not more than 15 mm.

6. The method according to claim 1, wherein in the projection, the projection length to the projection end is not less than 2 times to not more than 15 times the thickness of the rolled active material-containing layer.

7. The method according to claim 1, wherein in the coating of the surface of the current collector with the active material-containing layer, the current collector is coated with the active material-containing layer such that a dimension of the uncoated region in the widthwise direction of the belt-like member is larger than 25 mm.

8. The method according to claim 1, further comprising forming the current collector from one or more of aluminum, an aluminum alloy, copper, zinc, stainless steel, and titanium.

9. A manufacturing apparatus of electrode structure comprising:
a conveyance unit configured to convey a belt-like member in which a surface of a current collector is coated with an active material-containing layer, and an uncoated region not coated with the active material-containing layer is formed in one of a pair of long edges along the longitudinal direction and a vicinity thereof in the current collector;
a rolling unit configured to roll the active material-containing layer in the conveyed belt-like member;
a pulling unit configured to pull the belt-like member toward a downstream side, on the downstream side of the rolling unit, thereby applying a tension in the longitudinal direction to the belt-like member between the pulling unit and the rolling unit; and
an enlarging unit including a roller and a projection projecting toward an outer peripheral side in the roller, and installed between the rolling unit and the pulling unit, the enlarging unit being configured to enlarge the uncoated region of the current collector in the longitudinal direction by pushing the uncoated region by the projection against the belt-like member to which the tension is applied, and a projection length of the projection to a projection end being larger than a thickness of the active material-containing layer rolled by the rolling unit.
